(19) United States
(12) Patent Application Publication
(10) Pub. No.: US 2002/0109269 A1
(43) Pub. Date: Aug. 15, 2002

(54) Method of fabricating honeycomb body and drying system

(75) Inventors: Yasunao Miura, Nagoya-city (JP); Tomio Minobe, Fujimi-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/045,083

(22) Filed: Jan. 15, 2002

(30) Foreign Application Priority Data
Jan. 16, 2001 (JP) 2001-7930
Dec. 4, 2001 (JP) 2001-370395

(51) Int. Cl. H05B 6/64

(52) U.S. Cl. 264/432

(57) ABSTRACT

A method of fabricating at least a honeycomb body and a drying system are disclosed. A honeycomb mold having a cell wall thickness of not larger than 0.125 mm can be dried without developing any cracking or wrinkles in the outer peripheral skin portion. In a method of fabricating a honeycomb mold (1) of ceramics having a multiplicity of cells (10) defined by the cell walls (11) having a thickness of not more than 0.125 mm arranged in the shape of honeycomb, each extrusion-molded argillaceous honeycomb body (1) is dried by being exposed to a high-humidity ambience of 70% or more while at the same time being irradiated with microwaves in the frequency range of 1,000 to 10,000 MHz.

### BACKGROUND OF THE INVENTION

1. Field of the Invention

The present invention relates to a method of fabricating at least a honeycomb body or, in particular, to a drying process and a drying system.

2. Description of the Related Art

In fabricating at least a honeycomb body of ceramic, an argillaceous honeycomb body is extrusion molded, dried and baked. A method of drying at least a honeycomb body is known, which, as described in Japanese unexamined Patent Publication No. 63-166745, uses the high frequency current generated by applying a voltage across the electrodes arranged at an upper portion and a lower portion of the honeycomb body. This method is intended to heat the inside and the outside of the honeycomb body uniformly thereby to prevent such defects as cracking and wrinkling which may by caused by the shrinkage difference attributable to a difference in the drying rate.

The drying method described above is effectively applicable to a honeycomb body having a cell wall thickness of 0.30 to 0.15 mm and an outer peripheral skin thickness of 0.3 to 1.0 mm generally used in the prior art as a catalyst carrier of an exhaust gas purification system of an automobile. In a thin-wall honeycomb body having the cell wall thickness of not more than 0.125 mm and the outer peripheral skin thickness of not more than 0.5 mm recently developed to meet the need of an improved exhaust gas purification performance, however, the cell wall and the outer peripheral skin have a strength lower than those of the prior art. With this thin-wall honeycomb body, therefore, it is difficult to take a satisfactory measure to prevent defects in the outer peripheral portion by the conventional method using a high frequency current.

### SUMMARY OF THE INVENTION

The present invention has been developed in view of the problems of the prior art described above, and the object thereof is to provide a method of fabricating a honeycomb body and a drying system in which a honeycomb body having a cell wall thickness of not more than 0.125 mm can be dried without causing any defects such as the cracking or wrinkling of the outer peripheral skin thereof.

According to a first aspect of the invention, there is provided a method of fabricating at least a honeycomb ceramic body comprising a multiplicity of cells having the wall thereof not more than 0.125 mm thick, in which the extrusion-molded argillaceous honeycomb body is dried by being exposed to a high humidity ambience of not less than 70% in humidity and irradiated with microwaves having a frequency of 1,000 to 10,000 MHz.

In the fabrication method according to this invention, as described above, the honeycomb body is heated in a high-humidity ambience of not less than 70% in humidity. As a result, the outer peripheral surface of the honeycomb body can be prevented from drying so abruptly as to be deformed, and thus can be kept at the proper humidity. In this way, the difference in the drying rate between the outer peripheral surface and the interior of the honeycomb body can be reduced. Even in the case where the cell wall thickness is as small as not more than 0.125 mm and the thickness of the outer peripheral skin is comparatively small, therefore, the difference in shrinkage due to the drying rate difference between the exterior and the interior of the honeycomb body can be reduced. The cracking, wrinkling or the like defects can thus be prevented from developing in the outer peripheral skin portion. The higher the humidity of the high-humidity ambience, the more preferable. Thus, the humidity of 80% or more or even a supersaturated state is allowable.

Also, in this aspect of the invention, the microwaves described above are used as heating means. In this way, the heating in the high-humidity ambience described above can be realized. Specifically, in the conventional heating means with high frequency current, the electrodes are required to be arranged in proximity to the honeycomb body. This arrangement of the electrodes in the high-humidity ambience would cause the discharge or the dielectric breakdown between the electrodes thereby leading to an equipment malfunction.

Microwaves, in contrast, can be introduced through waveguides and no electrode is required to be arranged in the vicinity of the object to be heated. Microwaves can easily reach and heat the honeycomb body even in a high-humidity ambience.

As described above, in this aspect of the invention, even in the case where the cell wall thickness is as small as 0.125 mm and the outer peripheral skin portion is comparatively thin, the combination of the microwave heating means and the high-humidity ambience can sufficiently prevent the outer peripheral skin portion from cracking or wrinkling at the time of drying. The improved quality at the time of drying can achieve a high quality of the honeycomb body, as a baked product, obtained in the subsequent baking process.

According to a second aspect of the invention, there is provided a method of fabricating at least a honeycomb body, wherein the temperature of the high-humidity ambience is preferably not lower than 80° C. The temperature of the high-humidity ambience is not limited to produce the functions and effects described above, but may assume an arbitrary value. Nevertheless, the temperature of not lower than 80° C. makes it possible to suppress the release of heat to the ambience from the honeycomb body heated by the microwave and improve the efficiency of the microwave heating means.

According to a third aspect of the invention, there is provided a method of fabricating at least a honeycomb body, wherein the high-humidity ambience is preferably formed by being supplied with high-temperature steam. For increasing the humidity to form the high-humidity ambience, a method can be employed to introduce steam positively. The steam which can be used for this purpose include the high temperature steam generated by the boiler or the like or the low-temperature steam generated by ultrasonic means or centrifugal force. Especially, the use of the high-temperature steam is more preferable as it can easily increase the temperature of the high-humidity ambience.

In the case where a conveyance tray composed of a specific porous ceramic is used, the steam can also be supplied through the pores of the conveyance tray.

According to a fourth aspect of the invention, there is provided a method of fabricating at least a honeycomb body, wherein the drying process described above is preferably carried out by measuring the temperature of the honeycomb body and changing the conditions for microwave radiation in accordance with the measured temperature. In such a case, the honeycomb body can be prevented from being excessively heated. Thus, the excessive heating attributable to overdrying in the microwave drying process can be prevented.

Microwaves can always be radiated properly by controlling the temperature of the honeycomb body during the drying process. Even in the case where the cell wall thickness is as small as 0.125 mm and the outer peripheral skin portion is comparatively thin, therefore, the cracking or wrinkling of the outer peripheral skin portion during the drying process can be prevented even more sufficiently.

According to a fifth aspect of the invention, there is provided a method of fabricating at least a honeycomb body, wherein the temperature of the honeycomb body is preferably measured by use of an infrared radiation thermometer or a laser thermometer. The use of the infrared radiation thermometer or the laser thermometer makes it possible to measure the temperature of the honeycomb body without contacting the mold. Also, the infrared ray and the laser are not effected by the microwaves. Even with the honeycomb body exposed to the high-humidity ambience and irradiated with microwaves, therefore, the temperature can be accurately measured in real time.

According to a sixth aspect of the invention, there is provided a system for drying at least an extrusion-molded argillaceous honeycomb body to fabricate at least a honeycomb body of ceramic composed of a multiplicity of cells arranged in the shape of honeycomb with the cell wall not thicker than 0.125 mm, the drying system comprising a drying bath for accommodating a plurality of honeycomb bodies, a humidifier for creating a high-humidity ambience of not lower than 70% in humidity in the drying bath, and a plurality of microwave generators for supplying microwaves, in the frequency range of 1,000 to 10,000 MHz, into the drying bath.

By using the drying system described above, the drying process of the fabrication method can be easily realized to produce a high-quality honeycomb body. Specifically, the honeycomb bodies to be dried are placed in the drying bath, and the internal humidity of the drying bath is increased to at least 70% by the humidifier thereby to create the high-humidity ambience. The honeycomb bodies can be heated in the high-humidity ambience by introducing microwaves from the microwave generators described above. As a result, each honeycomb body can be dried without generating any cracking or wrinkling in the outer peripheral skin portion thereof.

The drying system described above can be of either a continuous type or a batch type. In the continuous drying system, a plurality of honeycomb bodies are sequentially supplied to and taken from the drying bath.

According to a seventh aspect of the invention, there is provided a system for drying at least a honeycomb body, wherein the humidifier preferably includes a high-temperature steam source for generating a high-temperature steam. The high-temperature steam source may be a boiler, In this case, both the temperature and the humidity of the high-humidity ambience can be easily increased.

According to an eighth aspect of the invention, there is provided a system for drying at least a honeycomb body, preferably comprising means for measuring the temperature of each honeycomb body being dried, and control means for changing the conditions for microwave radiation in accordance with the measured temperature. In this way, the honeycomb body can be prevented from being excessively heated by overdrying, and even in the case where the cell wall is as thin as 0.125 mm and the outer peripheral skin portion is comparatively thin, the outer peripheral skin portion can be prevented from developing cracking or wrinkling in the drying process.

According to a ninth aspect of the invention, there is provided a system for drying at least a honeycomb body, preferably comprising a drying bath having a transparent partitioning wall formed in a part thereof, and means arranged outside the drying bath for measuring the temperature of the honeycomb body through the transparent partitioning wall without contacting the honeycomb body. By arranging the noncontact temperature measuring means outside the drying bath as described above, the temperature of the honeycomb body can be stably measured with a compact, simplified configuration.

According to a tenth aspect of the invention, there is provided a system for drying at least a honeycomb body, wherein the temperature measuring means is preferably an infrared thermometer or a laser thermometer. Using the infrared thermometer or the laser thermometer, the temperature of the honeycomb body in the microwave can be measured with high accuracy and with a comparatively compact configuration.

According to an 11th aspect of the invention, there is provided a system for drying at least a honeycomb body, wherein the transparent partitioning wall constituting a part of the drying bath is preferably made of glass or a rigid plastic. It is the requirement of the transparent partitioning wall not to adversely affect the temperature measurement by the noncontact thermometer, not to be heated by the microwave and not to develop any chemical reaction in the high-humidity ambience of the drying bath or otherwise cause any change of properties. As long as these requirements are met, the transparent partitioning wall may be made of any material without any limitation. Nevertheless, glass or rigid plastics can be easily acquired and can exhibit the required performance for many years.

According to a 12th aspect of the invention, there is provided a system for drying at least a honeycomb body, preferably further comprising water-removing means for preventing water drips from attaching on that surface of the transparent partitioning wall making up a part of the drying system which is nearer to the drying bath. In measuring the temperature of the honeycomb body using the noncontact thermometer described above, the error which otherwise might be caused by the water drips attached on the surface of the transparent partitioning wall can thus be suppressed.

According to a 13th aspect of the invention, there is provided a system for drying at least a honeycomb body, wherein the water-removing means is preferably a blower for blowing the air onto the surface of the transparent partitioning wall nearer to the drying bath. By blowing the air in the manner described above, water drips can be prevented from attaching to the surface of the transparent partitioning wall with a comparatively compact, simplified device.

According to a 14th aspect of the invention, there is provided a system for drying at least a honeycomb body, wherein the blower preferably is configured to have a capacity of not less than 0.5 m³/min. In the case where the capacity of the blower is less than 0.5 m³/min. water drips could be fully prevented from attaching onto the surface of the transparent partitioning wall.

### BRIEF DESCRIPTION OF THE DRAWINGS

FIG. 1 is a diagram for explaining a configuration of the drying system according to a first embodiment of the invention.

FIG. 2(a) is a perspective view of a honeycomb body, and FIG. 2(b) is a diagram for explaining the cell wall thickness, according to a first embodiment of the invention.

FIG. 3 is a diagram for explaining the relation between the internal humidity of the drying bath and the cracking/wrinkling defective fraction according to a second embodiment of the invention.

FIG. 4 is a diagram for explaining the relation between the porosity of the conveyance tray, the internal humidity of the drying bath and the elution of the honeycomb body.

FIG. 5 is a diagram for explaining a configuration of the drying system according to a fourth embodiment of the invention.

FIG. 6 is a diagram for explaining a method of measuring the temperature of the drying system according to a fifth embodiment of the invention.

### DESCRIPTION OF THE PREFERRED EMBODIMENTS

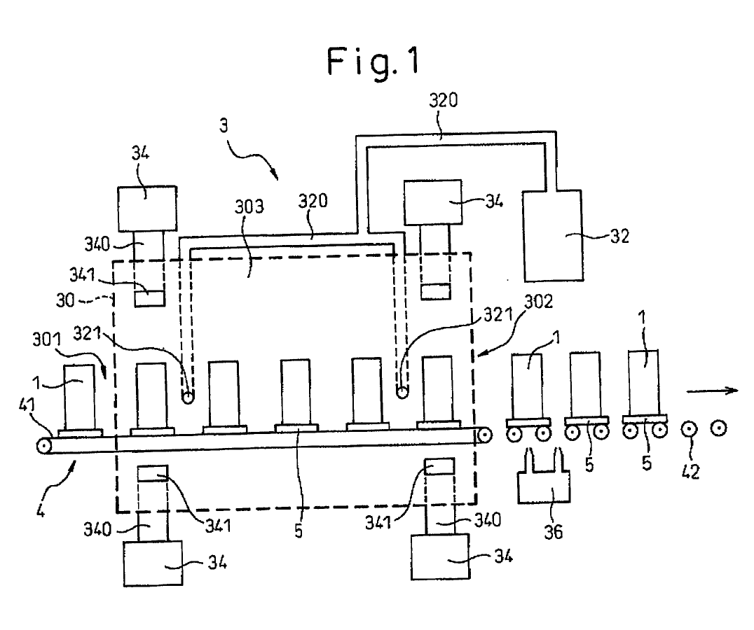

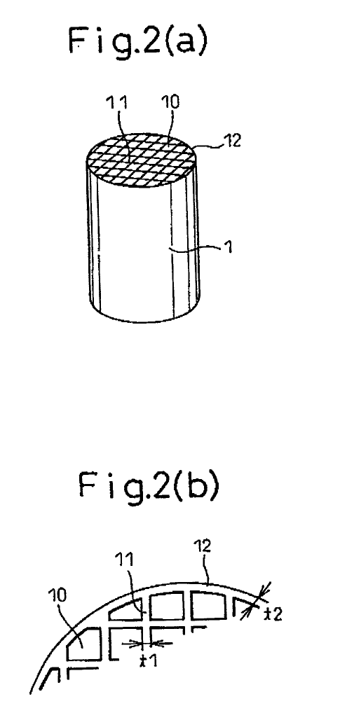

A method of fabricating at least a honeycomb body and a drying system according to an embodiment of the invention will be explained with reference to FIGS. 1, 2(a) and 2(b).

This embodiment, as shown in FIGS. 2(a) and 2(b), represents a method of fabricating a honeycomb body 1 of ceramic including a multiplicity of cells 10 arranged in the shape of honeycomb with a plurality of cell walls 11 having a thickness t1 not more than 0.125 mm. The honeycomb body according to this embodiment, as shown in FIGS. 2(a) and 2(b), includes a plurality of square cells 10 and a cylindrical outer peripheral skin portion 12 having a thickness t2 not more than 0.5 mm. The aforementioned shapes of the cells and the shape of whole honeycomb body can be changed in accordance with a specific application.

In the method according to this embodiment, the argillaceous honeycomb body 1 produced by an extrusion molding method is dried by being exposed to a high-humidity ambience of not less than 70% in humidity while at the same time being irradiated with microwaves in the frequency range of 1,000 to 10,000 MHz.

A detailed explanation of this embodiment will be made below.

In fabricating the honeycomb body 1 according to this embodiment, the first step is to add an organic binder at 5 parts by weight and water at 15 parts by weight to a ceramic power material, mainly of cordierite, of 100 parts by weight, and knead the mixture thereby to make an argillaceous ceramic material.

The next step is to extrude the ceramic material from a honeycombed die using an extrusion molding machine (not shown), and sequentially cutting the extruded honeycomb body stock into a plurality of molds of a predetermined length to thereby produce a plurality of argillaceous honeycomb bodies 1, The extrusion molding machine used is of plunger type, auger type, etc.

According to this embodiment, the slit width of each cell wall portion of the honeycombed die is set to 0.115 mm and the slit width of the outer peripheral skin portion thereof to 0.3 mm.

The thin-wall honeycomb bodies 1 obtained by extrusion molding as described above are dried using a drying system 3 shown in FIG. 1.

The drying system 3, as shown in FIG. 1, comprises a drying bath 30 for accommodating the honeycomb bodies 1, a humidifier 32 for creating a high-humidity ambience of not lower than 70% in humidity in the drying bath 30, and a plurality of microwave generators 34 for supplying microwaves in the frequency range of 1,000 to 10,000 MHz into the drying bath 30.

The drying bath 30 has such a size as to accommodate a plurality of the honeycomb bodies 1 transported by a conveyor system 4 described later.

Waveguides 340 extended from the four microwave generators 34, respectively, are connected and open at the four corner portions of the side wall 303 of the drying bath 30. These openings constitute microwave introduction ports 341.

Also, two steam pipes 320 extending and branching from a boiler constituting the humidifier 32 are connected and opened to two longitudinal points of the side wall 303. These openings make up steam introduction ports 321. The steam introduced by way of the steam introduction ports 321 is a high-temperature steam sent from the boiler as described above and is not lower than 80° C. in temperature.

The drying system 3 according to this embodiment also comprises a conveyor system 4 for conveying the honeycomb bodies. This conveyor system 4 is configured as a continuous system to deliver a plurality of the honeycomb bodies 1 continuously to and from the drying bath 30.

Specifically, a belt conveyor 41 connecting the inlet portion 301 and the outlet portion 302 of the drying bath 30 is arranged in the drying bath 30. Also, a roller conveyor 42 is arranged outside the outlet portion of the drying bath 30.

The conveyor system 4 including the belt conveyor 41 and the roller conveyor 42 is configured to convey the conveyance trays 5 each with the honeycomb body 1 placed thereon. According to this embodiment, the conveyance tray 5 is made of porous ceramics, or cordierite in the present case, having a dielectric loss of not more than 0.1, a porosity of not less than 10% and a sectional open area ratio of not less than 50%. This material can be replaced with urea resin, etc. On each conveyance tray 5, one of the open end surfaces (101) of the cells 10 of the honeycomb body 1 is placed in contact with the upper surface 51 of the conveyance tray 5. As a result, the cells 10 of the honeycomb body 1 are directed in the vertical direction and communicate with the pores of the conveyance tray 5.

A hot air generator 36 is arranged under the roller conveyor 42 outside the drying bath 30. This hot air generator 36 is configured to blow hot air, at 120° C., upward from under the conveyance trays 5 moving on the roller conveyor 42. This temperature is not high enough to burn the binder contained in the honeycomb bodies 1.

In drying the extrusion-molded honeycomb body 1 using the drying system configured as described above, the first step is to place each of the honeycomb bodies 1 of a predetermined length on the conveyance tray 5 and further to sequentially place the resulting pairs of the mold 1 and the tray 5 on the belt conveyor 41, as shown in FIG. 1. The honeycomb bodies 1 are thus sequentially transported into the drying bath 30.

Each honeycomb body 1 sent into the drying bath 30 is dried while moving toward the outlet 302 from the inlet 301 with the movement of the belt conveyor 41.

The interior of the drying bath 30 provides a high-humidity ambience maintained at a humidity of not less than 70% (not less than 80% in this embodiment) and a temperature of not lower than 80° C. by the high-temperature steam introduced from the humidifier 32. At the same time, the microwaves generated by the microwave generator 34 are introduced into the drying bath 30. As a result, the honeycomb bodies 1 in the drying bath 30 are rapidly dried while being prevented from developing cracking or a wrinkling of the outer peripheral skin portion 12 thereof.

Specifically, as the drying bath 30 is maintained in a high-temperature high-humidity ambience as described above, the honeycomb body 1 being heated is not dried so abruptly as to deform the outer peripheral surface thereof but is maintained at an appropriate temperature. Thus, the difference in drying rate between the outer peripheral surface and the interior of the honeycomb body 1 can be reduced, Even with the honeycomb body 1 having a cell wall as thin as not more than 0.125 mm as in this embodiment, therefore, the difference in shrinkage between inside and outside of the honeycomb body 1 due to the difference in drying rate can be reduced. As a result, the outer peripheral skin portion 12 can be prevented from developing such a defect as cracking or wrinkling.

Also, in this embodiment, microwaves are used as the heating means. Microwaves can be easily introduced through waveguides 70 even in the case where the interior of the drying bath 30 forms a high-humidity ambience as described above. Thus, the honeycomb body 1 can be easily heated dielectrically without any complicated equipment configuration.

As described above, according to this embodiment, even in the case where the cell wall thickness is not more than 0.125 mm and the thickness of the outer peripheral skin portion is not more than 0.3 mm, the development of cracking or wrinkling of the outer peripheral skin portion at the time of drying can be sufficiently prevented by the combined microwave heating and high-humidity ambience.

Further, in this embodiment, after the drying process by the high-humidity ambience in the drying bath 30, the hot air generated from the hot air generator 36 is applied to the honeycomb body 1 in such a manner as to pass through the cells 10 thereof. Specifically, according to this embodiment, the honeycomb body 1 is dried by the combination of the microwave heating process and the hot air in the high-humidity ambience, More specifically, the honeycomb body 1 is dried first by heating it by microwaves in the high-humidity ambience to such an extent that the water content of the honeycomb body remains at 10 to 20% of the figure before drying. After that, the honeycomb body 1 is dried completely by hot air to attain a water content of not more than 5%.

As a result, the heating by microwaves in the high-humidity ambience can be easily controlled, thereby preventing such an inconvenience as burning off the binder component of the honeycomb body by excessive heating with microwaves. In this way, complete drying can be realized with high accuracy by hot air not high enough in temperature to cause excessive heating.

The drying system 3 according to this embodiment comprises the conveyance system 4 as described above and has a configuration capable of continuous operation. For this reason, the drying process can be performed very efficiently.

Further, the conveyance trays 5 according to this embodiment employ a specific porous ceramic called cordierite having the dielectric loss of not more than 0.1, a porosity of not less than 10% and a sectional open area ratio of not less than 50%. As a result, during the drying process by microwaves, water can be prevented from stagnating and the conveyance trays 5 can be prevented from increasing in temperature. Further, during the heating with hot air, the hot air can easily pass into the cells 10 through the pores.

(Second embodiment)

According to this embodiment, a test is conducted to determine the correlation between the humidity and the quality of the outer peripheral skin portion by changing the humidity by changing the amount of the high-temperature steam introduced to the drying bath 30 using the drying system 3 according to the first embodiment. The same conditions are employed as those for the first embodiment except for humidity.

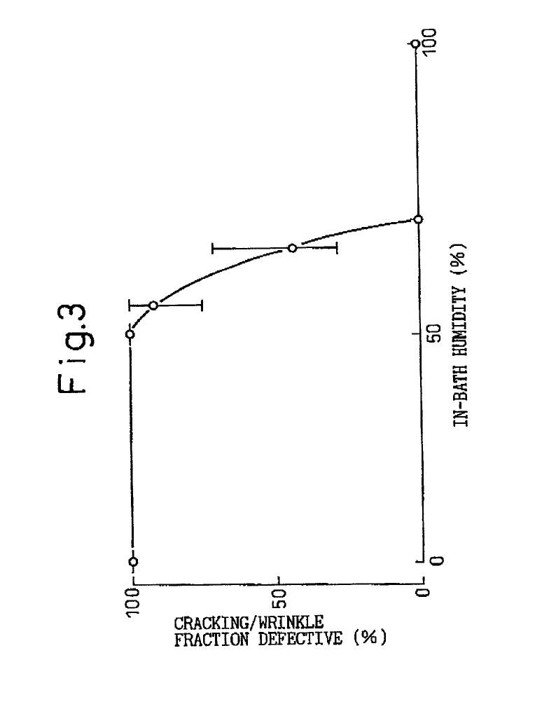

The test result is shown in FIG. 3. In FIG. 3, the abscissa represents the internal temperature of the drying bath 30, and the ordinate the cracking/wrinkling fraction defective of the outer peripheral skin portion. In each session of the test, 20 honeycomb bodies are processed, and by determining the percentage of those honeycomb bodies which have developed even a small amount of cracking or wrinkling as defective products, the ratio of the number of defective products is calculated as the fraction defective.

As seen from FIG. 3, it has been found that the effect of cracking/wrinkling prevention begins to be exhibited at a humidity higher than 50%, and the cracking and wrinkles can be almost completely prevented at the humidity of not less than 70%.

(Third embodiment)

According to this embodiment, a test is conducted to check for any malfunction due to the water stagnation during the drying process by changing both the porosity of the conveyance tray 5 and the internal humidity of the drying bath 30 in the first embodiment. The conditions other than the porosity of the conveyance tray 5 and the humidity in the drying bath 30 are similar to the corresponding figures in the first embodiment.

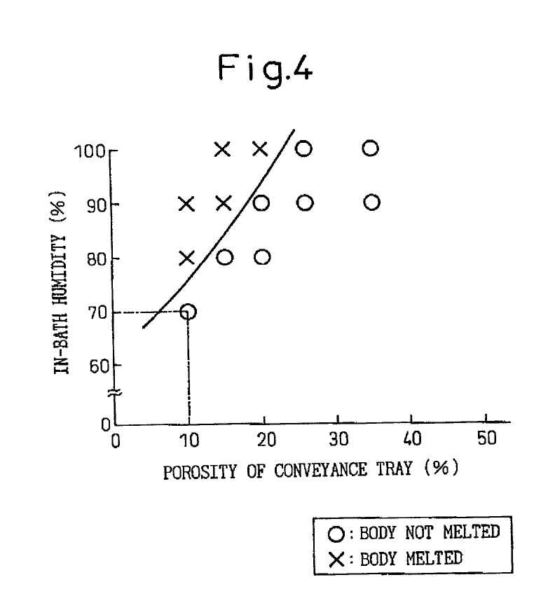

The test result is shown in FIG. 4. In FIG. 4, the abscissa represents the porosity of the conveyance tray, and the ordinate the humidity of the drying bath. one session of the drying process is conducted under each condition, and a graph is plotted by indicating with X a case in which even a small elution occurs of the cell wall or the outer peripheral skin portion, and ∘ a case in which no such elution occurs.

As seen from FIG. 4, the higher the humidity, the easier the elution occurs. In the case where the humidity is at least 70%, the elution can be prevented by setting the porosity of the conveyance tray to not less than 10%. It is also seen that even at a humidity of 100%, the elution can be prevented by setting the porosity of the conveyance tray to not less than 25%.

(Fourth embodiment)

This embodiment represents a case using the drying system 6 of batch type.

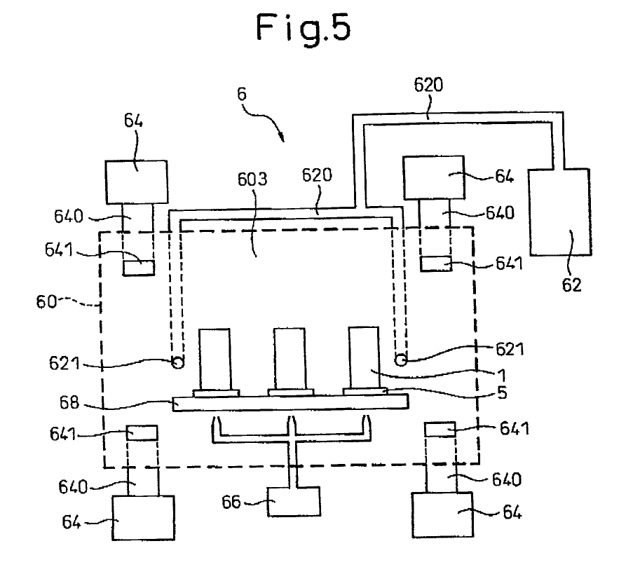

The drying system 6 according to this embodiment, as shown in FIG. 5, comprises a drying bath 60 for accommodating the honeycomb bodies 1, a humidifier 62 for creating a high-humidity ambience of not less than 70% in humidity in the drying bath 60, and a plurality of microwave generators 64 for supplying the interior of the drying bath 60 with microwaves in the frequency range of 1,000 to 10,000 MHz.

A rest 68 capable of supporting a plurality of the honeycomb bodies 1 each placed on the conveyance tray 5 is arranged in the drying bath 60. The rest 68 has air permeability as it is formed with a plurality of vertical through holes.

Also, waveguides 640 extending from the four microwave generators 64 are connected and opened at the four corner portions of one side wall 603 of the drying bath 60. These openings provide microwave introduction ports 641. Further, the drying bath 60 has an inlet and an outlet, not shown, by way of which the honeycomb bodies 1 can be delivered in and out.

Two steam pipes 620 extending from the boiler constituting the humidifier 62 and forming branches are connected and open at two lateral points of the side wall 603. These openings provide the steam introduction ports 621. The steam introduced from the steam introduction ports 621 is a high-temperature steam sent from the boiler as described above and has a temperature of not lower than 80° C.

According to this embodiment, the hot air generator 66 is arranged in the drying bath 60. This hot air generator 66 is configured to blow the hot air of 120° C. upward from under the rest 68. The hot air flows through the rest 68 and the conveyance trays 5 and passes through the cells 10 of the honeycomb bodies 1. The conveyance tray 5 is similar to the one used in the first embodiment.

In drying the mold 1 using the drying system 6, the first step is to place on the conveyance trays 5 a plurality of honeycomb bodies 1, of predetermined length, into which the honeycomb body stock is cut, and arrange them on the rest 68, as shown in FIG. 5. Under this condition, the high-temperature steam is introduced from the humidifier 62 into the drying bath 60 thereby to form a high-humidity ambience of not lower than 70% in humidity, while at the same time introducing microwaves from the microwave generator 64 for performing the microwave heating process.

In this embodiment, the microwave heating process is carried out in the high-humidity ambience to such an extent that the water content of the honeycomb body 1 is reduced to between 10 and 20%. After that, the introduction of both the high-temperature steam and the microwave is stopped. After ventilating the interior of the drying bath 60, the hot air is blown up from the hot air generator 66. As a result, the hot air that has passed through the rest 68 and the conveyance trays 5 is passed through the cells 10 of each honeycomb body 1. Thus, the water content of the honeycomb body 1 is reduced to 5% or less so that the honeycomb body 1 is complete dried.

After that, all the honeycomb bodies 1 are recovered from the drying bath 60, and then another batch of the honeycomb bodies 1 to be dried are arranged in the drying bath 60. In this way, the series of drying steps described above an be repeated.

As described above, according to this embodiment, a superior drying process can be implemented like the drying system 3 in the first embodiment, by using the drying system 6 of a batch type.

The other functions and effects are similar to those of the first embodiment.

(Fifth embodiment)

This embodiment represents a case in which the drying process described above is carried out while controlling the temperature of the honeycomb bodies 1 in the drying bath.

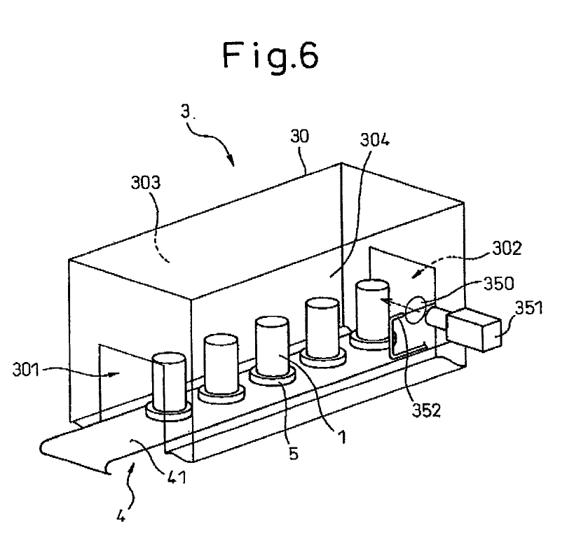

As shown in FIG. 6, the drying system 3 is used to carry out this drying process. The drying system 3 according to this embodiment comprises means for measuring the temperature of the honeycomb bodies 1 in the drying bath 30 and a configuration for changing the microwave output in accordance with the measured temperature, in addition to the configuration of the first embodiment.

According to this embodiment, the temperature measuring means is made up of an infrared radiation thermometer 351, Specifically, a transparent partitioning wall 350 is formed as a part of the side wall 304 of the drying bath 30, and the infrared radiation thermometer 351 is arranged at a position from which the honeycomb body 1 in the drying bath 30 is visible through the transparent partitioning wall 350.

Also, in order to prevent water drips from attaching on the inner surface of the transparent partitioning wall 350, the air is constantly introduced by way of an air pipe 352.

Further, the infrared radiation thermometer 351 and the microwave generators 34 are connected to each other by a signal line not shown.

According to this embodiment, glass is employed as the material of the transparent partitioning wall 350 but can be replaced with a hard plastic with equal effect.

Also, the temperature measuring means may be a laser thermometer instead of the infrared radiation thermometer 351.

As described above, the drying process for the honeycomb bodies 1 is implemented using the drying system 3 having the above-mentioned configuration.

In this embodiment, the temperature of each honeycomb body 1 is measured by the infrared thermometer 351 through the transparent partitioning wall 350 based on the wavelength of the infrared light radiated from the particular honeycomb body 1 in the drying bath 30.

In the process of measuring the temperature, air is constantly blown at the rate of 0.5 m³/min onto the inner surface of the transparent partitioning wall. Even in the case where a high-humidity high-temperature ambience is formed in the drying bath 30, therefore, water drips are prevented from attaching onto the inner surface of the transparent partitioning wall, thereby making accurate temperature measurement possible.

In accordance with the temperature thus measured, the on/off control operation of the microwave generators 34 is performed. Specifically, in the case where the temperature of the honeycomb body 1 is not lower than 110° C., microwaves are not supplied from the microwave generators 34. In the case where the temperature is not higher than 80° C., on the other hand, the supply of microwaves is resumed, from the microwave generators 34.

The other points of configuration, functions and effects are similar to those of the first embodiment.

In the drying system 3 according to this embodiment, the microwave drying process can be carried out while maintaining the temperature of the honeycomb body 1 at about 100° C. According to this embodiment, therefore, the excessive heating at the time of microwave drying can be prevented. In this way, according to this invention, the honeycomb bodies 1 can be dried while maintaining a superior quality thereof in the drying process.

In spite of the fact that the microwave generators 34 are subjected to on/off control in the embodiment described above, the invention is not limited to such a control method. In the case where the honeycomb body 1 reaches 130° C. higher than during the on/off control, for example, the supply of microwaves can be stopped without taking other measures.

By performing the control operation in this way, the honeycomb bodies 1 can be prevented from being excessively dried.

What is claimed is:

1. A method of fabricating at least a honeycomb body of ceramics comprising a multiplicity of cells having the wall thereof not more than 0.125 mm thick, in which at least an extrusion-molded argillaceous honeycomb body is dried by being exposed to a high-humidity ambience of not less than 70% in humidity and irradiated with microwaves having a frequency of 1,000 to 10,000 MHz.

2. A method of fabricating at least a honeycomb body according to claim 1, wherein the temperature of the high-humidity ambience is not lower than 80° C.

3. A method of fabricating at least a honeycomb body according to claim 1, wherein the high-humidity ambience is formed by being supplied with high-humidity steam.

4. A method of fabricating at least a honeycomb body according to claim 1, wherein the drying process described above is carried out by measuring the temperature of the honeycomb body and changing the conditions for microwave radiation in accordance with the measured temperature.

5. A method of fabricating at least a honeycomb body according to claim 1, wherein the temperature of the honeycomb body is measured by use of selected one of an infrared radiation thermometer and a laser thermometer.

6. In fabricating at least a honeycomb body of ceramics composed of a multiplicity of cells arranged in the shape of honeycomb with the cell wall not thicker than 0.125 mm, a system for drying at least an extrusion-molded argillaceous honeycomb body, comprising a drying bath for accommodating at least a honeycomb body, a humidifier for creating a high-humidity ambience of not lower than 70% in humidity in the drying bath, and at least a microwave generator for supplying microwaves in the frequency range of 1,000 to 10,000 MHz into the drying bath.

7. A system for drying at least a honeycomb body according to claim 6, wherein the humidifier includes a high-temperature steam source for generating a high-temperature steam.

8. A system for drying at least a honeycomb body according to claim 6, comprising means for measuring the temperature of the honeycomb body being dried, and control means for changing the conditions for microwave radiation in accordance with the measured temperature.

9. A system for drying at least a honeycomb body according to claim 8, comprising a drying bath having a transparent partitioning wall formed in a part thereof, and means arranged outside the drying bath for measuring the temperature of the honeycomb body, through the transparent partitioning wall, without contacting the honeycomb body.

10. A system for drying at least a honeycomb body according to claim 9, wherein the temperature measuring means is selected one of an infrared thermometer and a laser thermometer.

11. A system for drying at least a honeycomb body according to claim 10, wherein the transparent partitioning wall constituting a part of the drying bath is made of selected one of glass and a rigid plastic.

12. A system for drying at least a honeycomb body according to claim 9 or 10, further comprising water-removing means for preventing water drips from attaching on that surface of the transparent partitioning wall constituting a part of the drying bath which is nearer to the drying bath.

13. A system for drying at least a honeycomb body according to claim 12, wherein the water-removing means is a blower for blowing the air onto the surface of the transparent partitioning wall nearer to the drying bath.

14. A system for drying at least a honeycomb body according to claim 13, wherein the blower is configured to have a blowing capacity of not less than 0.5 m³/min.
